(19) United States
(12) Patent Application Publication
(10) Pub. No.: US 2011/0163485 A1
(43) Pub. Date: Jul. 7, 2011

(54) FORMING APPARATUS AND METHOD USING WATER PRESSURE OR VAPOR PRESSURE

(76) Inventor: Moon Ki Yea, Ulsan (KR)

(21) Appl. No.: 12/922,296

(22) PCT Filed: Sep. 10, 2009
(86) PCT No.: PCT/KR09/05146

§ 371 Date: Sep. 13, 2010

(51) Int. Cl. B29C 49/46

(52) U.S. Cl. 264/570; 425/522

(57) ABSTRACT

Provided is a forming method comprising fixing an object in a mold of a forming apparatus comprising a water pressure or vapor pressure generator and the mold communicated with the water pressure or vapor pressure generator; generating water pressure or vapor pressure using the water pressure or vapor pressure generator and then injecting the water pressure or vapor pressure into the mold; and forming the object fixed in the mold using pressure generated by the water pressure or vapor pressure, and a forming apparatus used in the same. According to the present invention, it is possible to form an under-cut portion and other fine shapes which could not be formed by a conventional forming method and also it is possible to solve the problems such as the thickness variation and the whitening phenomenon after the forming process.

### CROSS-REFERENCE(S) TO RELATED APPLICATIONS

The present invention claims priority of PCT/KR2009/005146, filed on Sep. 10, 2009, which is incorporated herein by reference.

### BACKGROUND OF THE INVENTION

1. Field of the Invention

The present invention relates to a forming apparatus and method using water pressure or vapor pressure.

2. Description of Related Art

Generally, in order to form a surface material such as artificial leather or decorative film, which is used as a high quality interior and exterior material applied to automobiles, electronic components and the like, there are used various working methods such as vacuum forming, hot press forming, low pressure injection molding, insert molding and so on.

However, in case of the vacuum forming, a material may be deformed by heat generated upon the forming process or bubbles may be generated. Further, since a deep-drawn body is extended while being non-uniformly contacted with a mold, a thickness thereof becomes non-uniform. Furthermore, in case of the vacuum forming, when printed patterns are formed on a surface of the formed body, the printed patterns may be out of focus on the formed body, due to the non-uniform forming.

In addition, in case of the forming using high pressure air, it is difficult to generate high pressure and since a film is forcibly drawn using high pressure air only, a whitening phenomenon may be generated on the formed body such as the film.

In case of the low pressure injection molding in which melt-phase resin is molded at the same time as injection of the resin, since fluidity of the resin is not high and also high temperature resin is directly contacted with a formed body, the formed body may be damaged. Further, since a thickness of the formed body is non-uniform due to pressure difference in a mold and also a surface of the formed body cannot be heated, the whitening phenomenon may be generated on the formed body.

In case of the hot press forming, it has the same problems as the above-mentioned forming methods, and also it is not possible to form a structure having a complicated shape, e.g., an under-cut portion.

### SUMMARY OF THE INVENTION

An embodiment of the present invention is directed to providing a forming apparatus and method using vapor or water pressure, which can induce uniform high pressure in a mold within a short time.

To achieve the object of the present invention, the present invention provides a forming method comprising fixing an object in a mold of a forming apparatus comprising a water pressure or vapor pressure generator and the mold communicated with the water pressure or vapor pressure generator; generating water pressure or vapor pressure using the water pressure or vapor pressure generator and then injecting the water pressure or vapor pressure into the mold; and forming the object fixed in the mold using pressure generated by the water pressure or vapor pressure.

Further, the present invention provides a forming apparatus comprising a water pressure or vapor pressure generator; and a mold which is communicated with the water pressure or vapor pressure generator and formed with a forming convex and concave portion for forming an object in the mold using pressure generated by water pressure or vapor pressure generated from the water pressure or vapor pressure generator.

### BRIEF DESCRIPTION OF THE DRAWINGS

FIG. 1 is a schematic view of a forming apparatus according to an embodiment of the present invention.

FIGS. 2 and 3 are mimetic diagrams showing a forming method according to an embodiment of the present invention.

FIG. 4 is photographs showing a sample A formed by a vacuum forming method and a sample B formed by the forming method of the present invention.

### DETAILED DESCRIPTION OF MAIN ELEMENTS

1: water pressure or vapor pressure generator

2: inlet/outlet port

3: mold

31: upper mold

32: lower mold

33: air discharging groove

34: fixing member

### DESCRIPTION OF SPECIFIC EMBODIMENTS

The present invention relates a forming method including fixing an object in a mold of a forming apparatus including a water pressure or vapor pressure generator and the mold communicated with the water pressure or vapor pressure generator; generating water pressure or vapor pressure using the water pressure or vapor pressure generator and then injecting the water pressure or vapor pressure into the mold; and forming the object fixed in the mold using the water pressure or vapor pressure injected into the mold.

The advantages, features and aspects of the invention will become apparent from the following description of the embodiments with reference to the accompanying drawings, which is set forth hereinafter.

The object applied in forming apparatus and method of the present invention may be a film such as artificial leather or various decorative films used as interior and exterior materials for automobiles, electronic components and so on. The present invention uses a forming apparatus including a water pressure or vapor pressure generator in forming the film as a surface material. Therefore, in the present invention, it is possible to efficiently a high pressure status which can apply uniform pressure to the object in a moment. Further, in the present invention, the water pressure or vapor pressure generator may be, for example, a water or steam generator. Accordingly, in the present invention, for example, water or steam is generated using the generator, and the generated water or steam is injected into the mold so as to induce the high pressure status in the mold, and thus it is possible to form the objet (e.g., film) using the pressure.

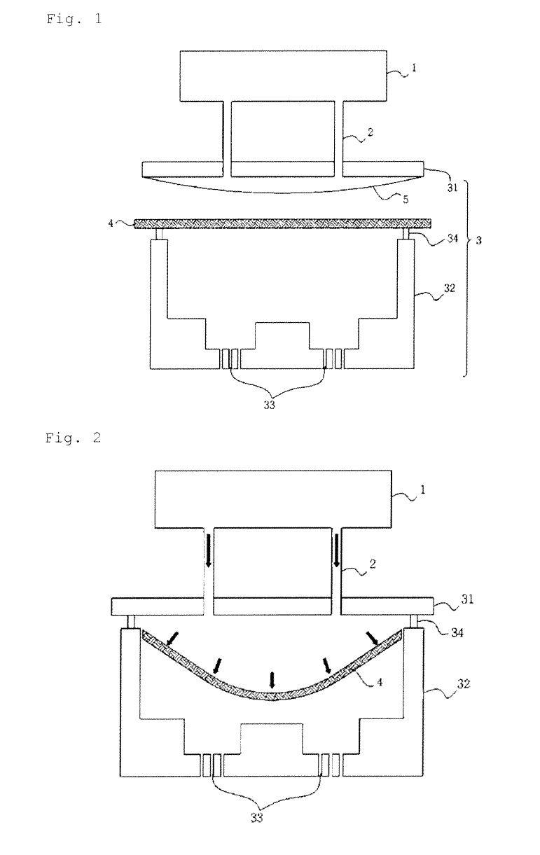

In the forming method according to the present invention, for example, a forming apparatus shown in FIG. 1 may be used. However, the forming apparatus of FIG. 1 is just an example of the present invention. In other words, besides the forming apparatus of FIG. 1, any other apparatus may be used in the present invention, if it includes a mold which can form the object (e.g., film) using the water pressure or vapor pressure generated from the water pressure or vapor pressure generator.

As shown in FIG. 1, the forming apparatus of the present invention includes, for example, a water pressure or vapor pressure generator 1, an inlet/outlet port 2 through which water pressure or vapor pressure generated from the water pressure or vapor pressure generator 1 is introduced into or discharged from a mold, and a mold 3 which is connected with the inlet/outlet port 2.

For example, the generator 1 included in the forming apparatus of FIG. 1 generates water and then injects the water into the mold 3 so as to form the water pressure for forming the object (e.g., film) or injects heated and/or pressed water into the mold 3 so as to form the water pressure for forming the object (e.g., film), or heats and/or presses the water so as to generate steam and then injects the steam into the mold 3 so as to form vapor pressure for forming the object (e.g., film).

Herein, a heating or pressing range is not restricted particularly, if it is possible to form the object (e.g., film) in the mold. For example, the water (water pressure) or steam (vapor pressure) generated from the generator 1 and used in forming the object (e.g., film) is pressed at a pressure of 150˜2,000 bar, preferably 150˜1,000 bar, more preferably 150˜500 bar, most preferably 150˜200 bar. If the pressure is less than 150 bar, it is apprehended that the water pressure or vapor pressure is not generated enough to form the object (e.g., film). If the pressure is larger than 2000 bar, it is apprehended that the object (e.g., film) is undesirably deformed or damaged.

Meanwhile, the water (water pressure) or steam (vapor pressure) generated from the generator 1 and used in forming the object (e.g., film) may be heated to a temperature of 30˜250° C., preferably 30˜180° C. If the temperature is less than 30° C., it is apprehended that the water pressure or vapor pressure is not generated enough to form the object (e.g., film). If the temperature is larger than 250° C., it is apprehended that the object (e.g., film) is undesirably deformed or damaged.

The inlet/outlet port 2 of the forming apparatus of FIG. 1 functions to introduce the water (water pressure) or steam (vapor pressure) generated from the generator 1 into the mold 3. One end of the inlet/outlet port 2 is connected with the generator 1, and the other end is connected with the mold 3.

The mold 3 of the forming apparatus of FIG. 1 is a place where the object (e.g., film) 4 is formed by the water pressure or vapor pressure generated from the generator 1. For instance, the mold 3 may include an upper mold 31 and a lower mold 32.

The upper mold 31 is connected with the inlet/outlet port 2 and also formed with a hole through which the water or steam introduced through the inlet/outlet port 2 is injected into the mold 3. And various convex and concave portions may be formed in the lower mold 32 according to a shape of the object (e.g., film) 4.

Therefore, for example, the object (e.g., film) can be located between the upper and lower molds 31 and 32.

The mold 3 may further include a fixing member 34 which fixes the object (e.g., film) 4. Herein, the fixing member 34 is not restricted particularly, if it functions to fix the object (e.g., film) 4 installed in the mold 3. For example, the fixing member 34 may be an O-ring made of silicone or soft urethane. By using the fixing member 34, the object (e.g., film) can be stably installed in the mold 3, and thus it is possible to perform a precise forming process.

The mold 3 may further include one or more air discharging grooves 33 which prevent an inner portion of the mold 3 from being excessively pressed when the water or steam is introduced through the inlet/outlet port 2 and the water pressure or vapor pressure is generated. For example, the air discharging groove 33 may be formed at the lower mold 32. The air discharging groove 33 is connected with a typical means (e.g., a vacuum pump and the like) which can discharge air from the mold 3.

By using the air discharging groove 33, it is possible to solve the problem that the inner portion of the mold 3 is excessively pressed. If necessary, by making the inner portion of the mold 3 vacuous upon the forming process using the water pressure or vapor pressure, it is possible to efficiently perform the forming process.

As shown in FIG. 1, the forming apparatus according to the present invention may further include a soft subsidiary member 5 which is attached to a lower side of the upper mold 31 so as to be located, for example, between the upper mold 31 and the object (e.g., film) 4. The soft subsidiary member 5 may be made of, for example, a flexible or expansible material which can be facilely deformed by the water pressure or vapor pressure generated from the generator 1. The soft subsidiary material may be made of chloroprene rubber, silicone rubber or soft urethane. In case that the forming apparatus includes the soft subsidiary member 5, it is possible to prevent damage of the object (e.g., film) 4 due to the water pressure or vapor pressure, and it is also possible to efficiently form an object (e.g., film) which has pores and the like and thus cannot be formed by the vacuum forming method.

In case that the soft subsidiary member 5 is provided, as described above, the water pressure or. vapor pressure generated from the generator 1 is exerted to the object (e.g., film) 4 via the soft subsidiary member 5 so as to form the soft subsidiary member 5. If necessary, the water pressure or vapor pressure is directly exerted to the object (e.g., film) 4 without the soft subsidiary member 5.

Hereinafter, a forming method using the above-mentioned forming apparatus will be described fully.

First of all, the object (e.g., film) 4 is fixed between the upper and lower molds 31 and 32.

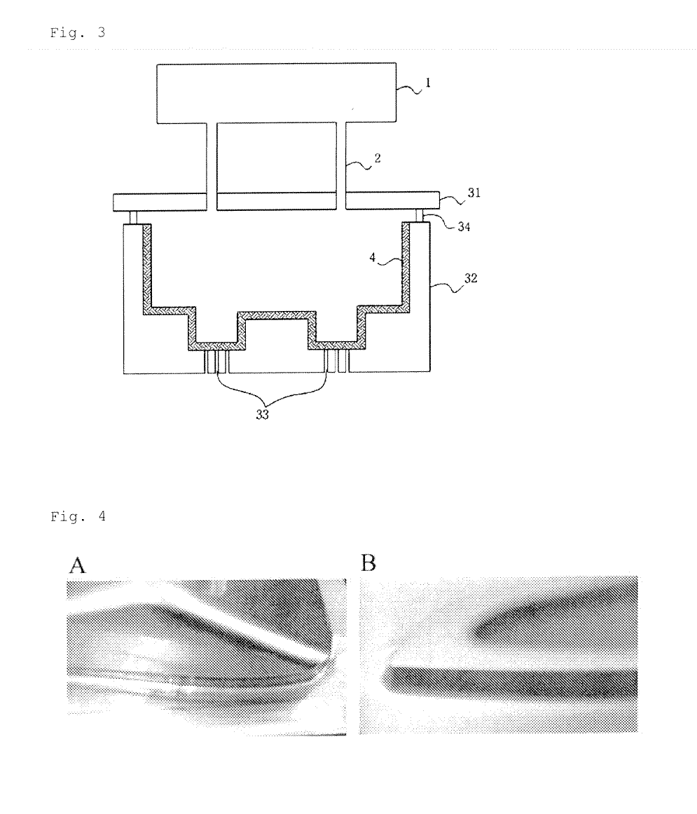

And, as shown in FIG. 2, the water (water pressure) or steam (vapor pressure) is generated using the generator 1 and then injected into the mold. Through this process, the water pressure or vapor pressure generated from the generator 1 is uniformly applied to the whole object (e.g., film) 4, and thus the object (e.g., film) 4 is moved to the lower mold 32. The moved object (e.g., film) 4 is deformed by the convex and concave portion formed in the mold, and thus it is possible to form the object (e.g., film) as shown in FIG. 3. In this process of the present invention, the air is properly discharged through the air discharging groove 33 formed at the mold, if necessary, it is possible to increase the forming efficiency by making the inner portion of the mold vacuous.

Since the present invention uses the water pressure or vapor pressure generated by the generator 1, the uniform pressure is exerted to the whole object (e.g., film) 4, it is possible to prevent a difference in thickness of a formed body after the forming process.

Further, since the present invention uses the water pressure or vapor pressure generated by the generator 1 and, if necessary, properly heated and/or pressed water pressure or vapor pressure, the object (e.g., film) 4 can be installed in the convex and concave portion within a short time, and thus the forming process can be complicated as shown, in FIG. 3.

According to the present invention as described above, if necessary, since the uniform pressure is applied to the whole object (e.g., film) by using the heated and/or pressed water pressure or vapor pressure, it is possible to form a structure having an under-cut portion and other fine shapes which could not be formed by an existing forming method (e.g., vacuum forming method). Furthermore, according to the present invention, it is possible to efficiently prevent the different in thickness of the formed body and also the whitening phenomenon of the object (e.g., film).

For example, as shown in FIG. 4, in a sample A which is formed by the vacuum forming method, its appearance is damaged, i.e., printed patterns are in disorder due to damage of printed lines. However, in a sample B which is formed by the forming method of the present invention, an edge portion and the like is clearly formed and thus the printed patterns are efficiently maintained.

Also, the present invention relates to a forming apparatus including a water pressure or vapor pressure generator and a mold which is communicated with the water pressure or vapor pressure generator and formed with a forming convex and concave portion for forming an object using the water pressure or vapor pressure generated from the generator.

The forming apparatus of the present invention may be an apparatus for forming various films as described above.

A construction of the forming apparatus of the present invention is not restricted particularly, and it may be have the construction as shown in FIG. 1.

In other words, the forming apparatus of the present invention may include an upper mold which is communicated with the generator and a lower mold which is formed with a convex and concave portion. Further, the forming apparatus may further include an air discharging groove formed at the lower mold.

Moreover, the forming apparatus of the present invention may further include an inlet/outlet port which is connected with the water pressure or vapor pressure generator and the upper mold so as to introduce water pressure or vapor pressure generated from the generator into the mold.

In addition, the forming apparatus of the present invention may further include a soft subsidiary member which is formed at a lower side of the upper mold.

Furthermore, the forming apparatus of the present invention may further include an O-ring which fixes the object in the mold, and the O-ring may be formed of silicone or soft urethane.

According to the present invention, the properly heated and/or pressed water pressure or vapor pressure can be injected into the mold in a moment, and the object is formed by using the water pressure or vapor pressure and thus process time thereof can be remarkably reduced. Further, the present invention efficiently form a structure having an under-cut portion and other fine shapes which could not be formed by a conventional forming method. Furthermore, in case that the object has printed pictures or printed patterns, it is possible to obtain a formed boy in which the printed pictures or printed patterns are in focus.

And in the present invention, it is possible to apply the uniform pressure to the whole surface area of the object using the water pressure or vapor pressure. Accordingly, the present invention can solve the conventional forming defect problem due to pressure drop or non-uniform pressure. Further, the high pressure can be embodied by a new method, which is more facile and cheaper than the conventional mechanical method.

And according to the present invention, it is possible to prevent the conventional problems such as whitening phenomenon, the thermal damage and the bubble generation, which are generated at the formed body after the forming process, and it is also possible to prevent other problems such as the difference in the coefficient expansion generated by temperature variation when being contacted with the mold, the wrinkle generation or thickness variation, and the contraction after the forming process.

In addition, since the present invention does not need a clamp used in the vacuum forming method, it is possible to increase space efficiency and considerably reduce loss of a material. Moreover, since the present invention does not need additional device such as a fixing means (e.g., clamp) of the object (e.g., material) and a heating device which is essential in the conventional forming method, and the single water pressure or vapor pressure generator can be connected with multiple forming devices (e.g., mold), it is possible to make better use of a working space and reduce entire investments.

While the present invention has been described with respect to the specific embodiments, it will be apparent to those skilled in the art that various changes and modifications may be made without departing from the spirit and scope of the invention as defined in the following claims.

What is claimed is:

1. A forming method comprising:
fixing an object in a mold of a forming apparatus comprising a water pressure or vapor pressure generator and the mold communicated with the water pressure or vapor pressure generator;
generating water pressure or vapor pressure using the water pressure or vapor pressure generator and then injecting the water pressure or vapor pressure into the mold; and
forming the object fixed in the mold using pressure generated by the water pressure or vapor pressure.

2. The method of claim 1, wherein the object is a film.

3. The method of claim 1, wherein the water pressure or vapor pressure generated from the water pressure or vapor pressure generator is 150˜2,000 bar.

4. The method of claim 1, wherein the water pressure or vapor pressure generated from the water pressure or vapor pressure generator is heated to a temperature of 30˜180° C.

5. The method of claim 1, wherein the forming of the object comprises discharging air to an outside of the mold.

6. A forming apparatus comprising:
a water pressure or vapor pressure generator; and
a mold which is communicated with the water pressure or vapor pressure generator and formed with a forming convex and concave portion for forming an object in the mold using pressure generated by water pressure or vapor pressure generated from the water pressure or vapor pressure generator.

7. The apparatus of claim 6, wherein the mold comprises an upper mold which is communicated with the water pressure or vapor pressure generator and a lower mold which is formed with a convex and concave portion.

8. The apparatus of claim 7, wherein the lower mold is formed with an air discharging groove.

9. The apparatus of claim 7, further comprising an inlet/outlet port which is connected with the water pressure or vapor pressure generator and the upper mold so as to inject the water pressure or vapor pressure generated from the water pressure or vapor pressure generator into the mold.

10. The apparatus of claim 7, further comprising a soft subsidiary member which is formed at a lower side of the upper mold.

11. The apparatus of claim 10, wherein the soft subsidiary member is made of chloroprene rubber, silicone rubber or soft urethane.

12. The apparatus of claim 6, wherein the mold further comprises an O-ring for fixing the object.

13. The apparatus of claim 12, wherein the O-ring is made of silicone or soft urethane.
